(19) United States
(12) Patent Application Publication
(10) Pub. No.: US 2015/0137418 A1
(43) Pub. Date: May 21, 2015

(54) METHOD AND MANUFACTURING FACILITY FOR CASTING CONCRETE PRODUCTS

(71) Applicant: ELEMATIC OY AB, Akaa (FI)

(72) Inventor: Jani EILOLA, Lempaala, FI (US)

(73) Assignee: ELEMATIC OY AB, Akaa (FI)

(21) Appl. No.: 14/541,217

(22) Filed: Nov. 14, 2014

(30) Foreign Application Priority Data
Nov. 15, 2013 (FI) 20136126

(51) Int. Cl. B28B 5/04

(52) U.S. Cl. CPC B28B 5/04; B28B 2005/048
USPC 264/241; 425/88

(57) ABSTRACT

A method and manufacturing facility for casting concrete products with a circulating line casting process, where molds are transferred through production stages along a circulating line, and reinforcements for the concrete products to be cast are prefabricated in a separate reinforcement shop and transferred to the circulating line casting process, wherein the reinforcements are transferred from the reinforcement shop with a carriage to the area located inside the circulating line casting process.

### BACKGROUND

1. Field

The present disclosure relates to casting of concrete products with a circulating line casting process. More precisely the present disclosure relates to a method and manufacturing facility used in the circulating line casting process.

2. Description of Related Art

A circulating line casting process is a casting process where the mold tables, on which the casting molds are built, are mounted on tracks and circulate through the phases of the casting process, after which the mold tables are returned for a new cycle.

The circulating line is formed of a plurality of work stations between which the casting mold is transferred in different stages of the casting process. In the first stage of the circulation line, the mold table is cleaned. In the next stage, the mold table is furnished with fixed and detachable mold sidewalls to form the casting mold in the mold table, and other required equipment, such as reinforcements, etc., are set on the mold. After the furnishing stage, casting of the concrete mass to the mold is carried out, together with required vibrating actions during the casting. The casting of the concrete mass into the mold can be carried out in different stages if, for example, different layers need to be added to the product to be cast, such as insulation layers in cases of insulated wall elements. When casting of concrete mass to the mold is done, the upper surface of the product to be cast is leveled and other required surface treatment steps are carried out. Next, the mold, together with the fresh cast product, is moved to the curing stage, which generally takes place at a curing chamber where temperature during the curing can be monitored and adjusted, if required. When the cast product is cured, the mold is taken to demolding, where the cast product is removed from the mold, generally together with tilting of the mold, and the mold sidewalls are removed from the mold table. After this stage, the mold is ready for a new cleaning stage and for the process of casting a new product.

In the furnishing stage, the required reinforcements, such as one or more metal lattice structures, are added and fixed in the mold after the mold is built in the mold table with mold sidewalls. These required reinforcements are generally prefabricated in a separate reinforcement shop and taken to the reinforcement work station of the circulating line. The prefabrication of the reinforcements allows for varying reinforcements to be prefabricated for each mold and each product to be cast, and thus minimizes the work and time required in the reinforcement work station of the circulating line.

The reinforcement shop is generally located at one end of the circulating line production facility, and the prefabricated reinforcements are moved to the reinforcement work station of the circulating line with a transfer carriage moving on track or rails extending along one side of the circulating line.

### SUMMARY

In an embodiment of the present invention, the area left inside of the circulating line is utilized for moving the reinforcements from the reinforcement shop to the reinforcement work station of the circulating line. This provides space savings in relation to prior solutions where the reinforcements are moved along the side of the circulation line. Further, the track and rails formed in the area inside the circulating line can also be utilized for other purposes, such as moving sidewall units from storage or from a washing station to the furnishing station. The present invention, in an embodiment, also allows for moving required material in the area inside the circulating line with a carriage along the floor level of the manufacturing facility, and without the need for lifting material over the circulation line, which enhances work safety and does not require or tie up a crane for the lifting.

In the method of an embodiment of the present invention, concrete products are cast with a circulating line casting process, where molds, or mold tables, are transferred through production stages along a circulating line, and reinforcements for the concrete products to be cast are prefabricated in a separate reinforcement shop and transferred to the circulating line, wherein the reinforcements are transferred from the reinforcement shop with a carriage to the area located inside the circulating line. Thus the transfer of the reinforcements is achieved without any lifting.

In the method of an embodiment of the invention, the carriage is advantageously moved along a track extending on a straight line from the reinforcements shop to the area located inside the circulating line.

The method of an embodiment of the invention may also include utilizing the track in the area located inside the circulating line for transferring material between production stages and work stations of the circulating line process.

The manufacturing facility of an embodiment of the present invention for casting concrete products with a circulating line casting process comprises a plurality of molds, or mold tables, a plurality of transfer tracks for transferring the molds along the circulating line from a work station to another, a reinforcement shop for prefabricating reinforcements for the concrete for the concrete products to be cast, and means or apparatus for transferring prefabricated reinforcements from the reinforcement shop to a work station of the circulating line, wherein the means or apparatus for transferring prefabricated reinforcements from the reinforcement shop to a work station of the circulating line comprises a carriage moved along a track extending from the reinforcement shop to an area located inside the circulating line.

The circulating line casting process is generally, and also in an embodiment of the present invention, formed of two straight and parallel production lines of production phases or work stations, which production lines are connected to each other with transversal transfer tracks at the ends of the production lines. The reinforcement shop is located typically at or near one end of the circulating line.

The manufacturing facility of an embodiment of the invention advantageously comprises another carriage on the track in the area located inside the circulating line for transferring material between work stations of the circulating line. Thus the area and track inside the circulating line can be utilized further.

In the manufacturing facility of an embodiment of the invention, the carriage for transferring the reinforcements comprises advantageously at least four pairs of wheels along its length for crossing the track of the of the circulating line. The transversal transfer tracks are generally located below the tracks extending along the production lines of the circulating line and the floor level of the manufacturing facility. Thus this type of carriage can advantageously cross the gap along its track at the area of the transversal transfer track without any further special structures for crossing the gap.

In the manufacturing facility of an embodiment of the invention, the circulating line casting process advantageously comprises at least two straight and parallel production lines formed of a plurality of workstations located next to each other in the direction of the production lines, and at least two transversal transfer tracks connecting the production lines. In the more simple circulating casting processes two parallel productions lines connected to each other at their ends with transversal transfer tracks is all that is required. However, more complex circulating line casting processes may require additional work stations located transversally outside the production lines together with additional transversal transfer tracks or means for transferring the molds or mod tables to these additional work stations, for example. Further, a more complex circulating route for the mold or mold table may be required, depending on the area available for the circulating line casting process, for example.

Advantageously the manufacturing facility of an embodiment of the invention comprises equipment for simultaneously implementing a plurality of circulating line casting processes with separate circulating line casting process lines, for example.

The features of a method according to an embodiment of the present invention are more precisely presented as relating to a method for casting concrete products with a circulating line casting process, where molds are transferred through production stages along a circulating line, and reinforcements for the concrete products to be cast are prefabricated in a separate reinforcement shop and transferred to the circulating line casting process, characterized in that the reinforcements are transferred from the reinforcement shop with a carriage to the area located inside the circulating line casting process. The features of a manufacturing facility of an embodiment of the present invention are more precisely presented as relating to a manufacturing facility for casting concrete products with a circulating line casting process, which facility comprises a plurality of molds or mold tables, a plurality of transfer tracks for transferring the molds along the circulating line casting process from a work station to another, a reinforcement shop for prefabricating reinforcements for the concrete products to be cast, and means for transferring prefabricated reinforcements from the reinforcement shop to a work station of the circulating line casting process, characterized in that the means for transferring prefabricated reinforcements from the reinforcement shop to a work station of the circulating line casting process comprises a carriage moved along a track extending from the reinforcement shop to an area located inside the circulating line casting process.

### BRIEF DESCRIPTION OF DRAWING

Exemplifying embodiments of the invention and its advantages are explained in greater detail below in the sense of example and with reference to accompanying drawing, where

FIG. 1 shows schematically a layout of a manufacturing facility according to an embodiment of the present invention.

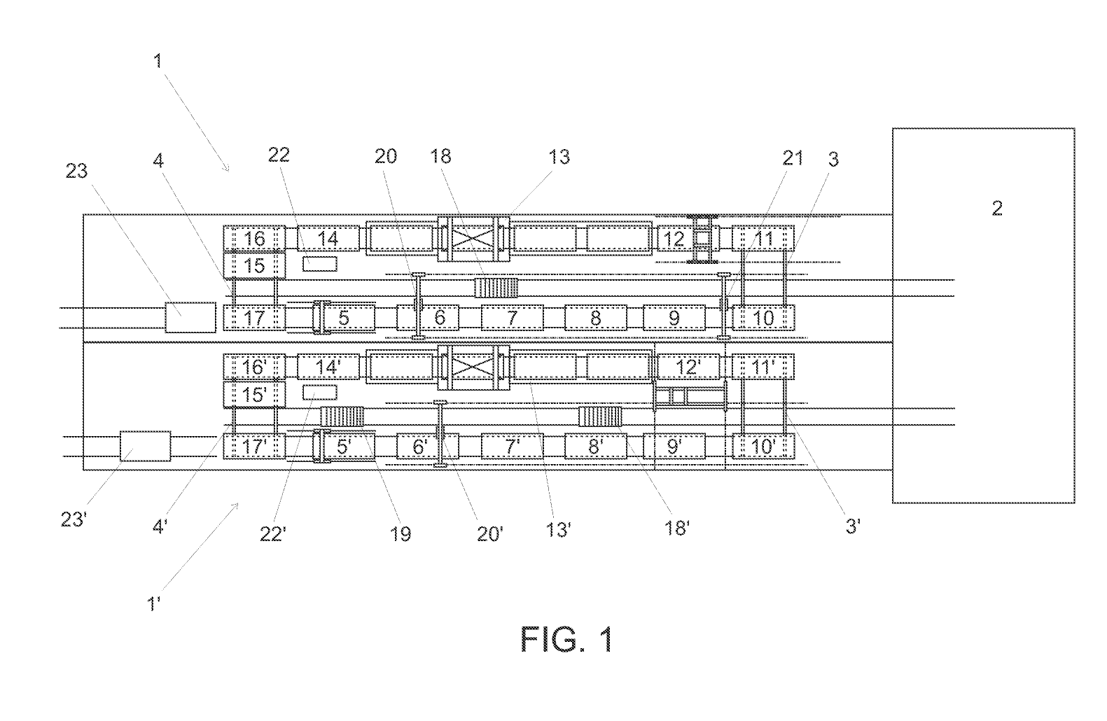

More specifically, FIG. 1 shows schematically a layout of a manufacturing plant, which comprises two circulating line casting processes 1, 1′ and a reinforcement shop 2.

### DETAILED DESCRIPTION OF SPECIFIC EMBODIMENTS

The circulating line casting processes 1, 1′ comprises plurality of work phases or work stations which are located side by side in the lengthwise direction of the processes in two separate work station lines, which two work station lines are connected to each other at transversal transfer tracks 3, 3′ and 4, 4′ located at both ends of the work station lines. The mold tables or molds are transferred from one work station to another along a track extending along the work station lines, and from one work station line to another with the transversal transfer tracks 3, 3′ and 4, 4′.

In the circulating line casting processes 1, 1′, the first work phase carried out in first work station 5, 5′ is the cleaning of the mold table, after which the mold table is moved to the furnishing stage, where mold sidewalls are fixed to the mold table to form the casting mold, which is carried out in work stations 6, 6′ and 7, 7′. Once the mold is ready, the required reinforcements are added and installed in the mold in work stations 8, 8′, 9, 9′, 10, 10′ and 11, 11′. Next the casting of the concrete mass is carried out in work station 12, 12′, after which the molds with cast products are moved to a curing chamber 13, 13′. In the curing chamber 13, 13′ the molds are stacked into stacks, so that plurality of concrete products in their molds can be cured simultaneously. Further, the curing chamber is also equipped with separate walls to form an enclosed area, and the temperature and humidity inside the curing chamber is modified in order to enhance the curing of the concrete products.

In the circulating line process 1′, the casting of the concrete mass into the mold can also be carried in two stages, first at reinforcements work station 9′ and then casting work station 12′. This allows casting of insulated wall elements, for example, where the wall element to be cast comprises an insulation layer that is added on top of the first cast concrete layer before another layer of concrete is cast on top of the insulation layer. Both of these concrete layers in the insulated wall element often also require separate reinforcements for each concrete layer.

Once the concrete products in their molds are cured, the molds are moved out of the curing chamber 13, 13′ to work stations 14, 14′ and 15, 15′ for demoulding, where the mold sidewalls are removed from the mold table. Between the demoulding work stations 14, 14′ and 15, 15′ is arranged additional buffer place 16, 16′, which can alternatively also be used as an additional demoulding work station. In the last phase, the cured concrete products are removed from the mold table in work station 17, 17′, which is implemented by tilting the mold table, fixing lifting hooks to lifting lugs located in the products, and lifting the concrete products with a crane from the work stations to separate removal carriages 23, 23′, the tracks of which are shown in the figure extending from the circulating line casting process lines, and moved to storage. When the cast concrete product is moved from the mold table, the mold table is moved to the work station 5, 5′ for cleaning and for a new casting process.

The reinforcements added and fixed to the molds are prefabricated in the reinforcement shop 2, and taken to the reinforcement work stations 8, 8′, 9, 9′, 10, 10′ and 11, 11′ of the circulating line casting processes 1,1′ with carriages 18, 18′, which carriages move along straight tracks extending from the reinforcement shop to the area inside the circulating line casting processes. There can be more than one carriage located in the same track, as is shown with a carriage 19 in the area located inside the circulating line casting process 1′. The manufacturing facility also comprises bridge cranes 20, 20′ and 21, for lifting and moving reinforcements and other material from the carriages 18, 18′ and 19 to the work stations of the circulating line casting processes 1, 1′.

As can be seen from the figure, the track of the carriages 18, 18′ and 19 crosses the transversal transfer tracks 3, 3′, which are generally located in a depressions formed on the floor of the manufacturing facility. Thus the carriages 18, 18′ and 19 advantageously comprises four or more pairs of wheels, so that there are always at least two wheels carrying the weight of the carriage when the carriage crosses over the transversal tracks 3, 3′.

The carriages 18, 18′ and 19 can also be used for moving other material than reinforcements to and between the work stations of the circulating line casting processes 1,1′. For example, the carriages 18, 18′, 19 can be used to move detachable mold sidewall units from washing and cleaning stations 22, 22′ to work stations 6, 6′ and 7, 7′ to be used in building of the mold on the mold table. Thus, as can be seen from the figure, the track of the carriages 18, 18′ and 19 also extends over the other transversal transfer tracks 4, 4′ so that the carriages can be moved next to a mold table for moving detachable sidewall units during demolding from the mold tables to the carriages.

In relation to the embodiment shown in FIG. 1 and discussed above, it should be noted that the circulating line processes 1, 1′ shown are more simple circulating casting processes. More complex circulating line casting processes may require additional work stations located transversally outside the production lines together with additional transversal transfer tracks or means for transferring the molds or mold tables to these additional work stations, for example. Further, a more complex circulating route for the mold or mold table may be required, depending on the area available for the circulating line casting process, for example.

The specific exemplifying embodiment of the invention shown in the figure and discussed above should not be construed as limiting. A person skilled in the art can amend and modify the embodiment in many evident ways within the scope of the attached claims. Thus the invention is not limited merely to the embodiments described above.

1. A method for casting concrete products with a circulating line casting process comprising:
transferring molds through production stages along a circulating line,
prefabricating reinforcements for the concrete products to be cast in a separate reinforcement shop
transferring the reinforcements from the reinforcement shop with a carriage to an area located inside the circulating line casting process; and
transferring the reinforcements to the circulating casting line process.

2. The method according to claim 1, wherein the carriage is moved along a track extending along a straight line from the reinforcements shop to the area located inside the circulating line casting process.

3. The method according to claim 2, wherein the track located in the area inside the circulating line casting process is also used to move material between the production stages and work stations of the circulating line casting process.

4. A manufacturing facility for casting concrete products with a circulating line casting process, which facility comprises:
a plurality of molds or mold tables,
a plurality of transfer tracks for transferring the molds along the circulating line casting process from a work station to another,
a reinforcement shop for prefabricating reinforcements for the concrete products to be cast, and
means for transferring prefabricated reinforcements from the reinforcement shop to a work station of the circulating line casting process, comprising a carriage moved along a track extending from the reinforcement shop to an area located inside the circulating line casting process.

5. The manufacturing facility according to claim 4, further comprising another carriage on the track for transferring material between work stations of the circulating line casting process.

6. The manufacturing facility according to claim 4, wherein the carriage comprises at least four pairs of wheels along its length for crossing the track of the circulating line casting process.

7. The manufacturing facility according to claim 4, further comprising at least one crane for moving reinforcements from the carriage to a reinforcement work station or work stations of the circulating line casting process.

8. The manufacturing facility according to claim 4, wherein the circulating line casting process comprises at least two straight and parallel production lines of work stations, and at least two transversal transfer tracks connecting the production lines.

9. The manufacturing facility according to claim 4, wherein the manufacturing facility comprises equipment for simultaneously implementing a plurality of circulating line casting processes.
